(19) United States
(12) Patent Application Publication
(10) Pub. No.: US 2011/0305247 A1
(43) Pub. Date: Dec. 15, 2011

(54) METHOD FOR SYNCHRONIZING CLOCKS BY SEPARATED TRANSMISSIONS OF FIRST AND SECOND DATA VIA AT LEAST ONE TIMING DISTRIBUTION PROTOCOL, AND ASSOCIATED SYSTEM AND MODULE

(75) Inventors: Michel Le Pallec, Nozay (FR); Jean Loup Ferrant, Boulogne Billancourt (FR)

(73) Assignee: ALCATEL LUCENT, Paris (FR)

(21) Appl. No.: 13/139,867

(22) PCT Filed: Mar. 11, 2010
(86) PCT No.: PCT/EP10/53118

§ 371 Date: Aug. 17, 2011

(30) Foreign Application Priority Data
Mar. 12, 2009 (EP) 09305227.2

(51) Int. Cl. H04J 3/06

(52) U.S. Cl. 370/503

(57) ABSTRACT

A method is intended for synchronizing a client clock of a client communication node with a master clock in a data packet network. This method comprises the steps of: i) transmitting first data representative of timing information of the master clock from a source communication node to the client communication node via a time distribution protocol, ii) transmitting second data representative of a frequency reference correlated to the timing information from a chosen communication node to the client communication node via a time distribution protocol, and iii) differentiating the transmitted first and/or second data into the client communication node to synchronize the client clock with the master clock by means of the timing information and/or frequency reference represented by the differentiated first and second data.

The present invention relates to data packet networks (or packet switched networks (PSNs)), and more precisely to synchronization of clocks in a data packet network.

As it is known by the man skilled in the art, some (stringent) client applications, running into client communication nodes, need a precise clock reference for running properly. This is notably the case of some mobile network applications (for instance used for base station synchronization).

This precise clock reference can be provided by a precise and highly stable client clock equipping the considered client communication node. But such a client clock is usually very expensive.

Another solution consists in transmitting data representative of timing information of a very precise master clock from a source communication node to the client communication node (connected to a data packet network) via a time distribution protocol, such as those referenced IETF NTPV4 (Network Time Protocol) and IEEE 1588V2, for instance. These above mentioned time distribution protocols are intended for transmitting information messages (or packets) containing timing information at regular intervals from a server (or source communication node) to one or more client communication nodes in order to synchronize the (low-cost) client clocks with the server (or master) clock. In fact, these information messages are bi-directional (or “round-trip”) messages exchanged between the server and a client (communication node). Generally, a client needs to receive a minimal number of (good or pertinent) information messages (or packets) from a server, during a given time interval, to properly synchronize its (low-cost) clock with the server clock.

One means here by “low-cost clock” a clock having a poor clock stability (i.e. a fast frequency drift in a free run mode) and/or poor capabilities for the filtering of the packet jitter.

From a time distribution perspective, the low-cost aspect implies a degraded time performance (notably in terms of accuracy) of the client clock in the locked mode comparatively to an expensive/efficient time client clock because the client clock should remain enough stable during the exchange of the bi-directional information messages (in order to decrease the convergence time for a given time accuracy target).

Moreover, if a failure occurs on the communication path (or link) between the master and the client, the client clock enters in a free run mode (or holdover) until reconfiguration of the synchronization topology. In this case, the lack of stability of the low-cost client clock may have a detrimental impact on the time accuracy during the reconfiguration time/delay of the synchronization topology.

So the object of this invention is to improve the frequency synchronization (or syntonization) of low-cost client clocks in data packet networks, and notably to avoid client clocks to enter into a free run mode.

For this purpose, the invention provides a method, intended for synchronizing a client clock of a client communication node with a master clock in a data packet network, and comprising the steps of:

i) transmitting first data representative of timing information of the master clock from a source communication node to the client communication node via a time distribution protocol,
ii) transmitting second data representative of a frequency reference correlated to the timing information from a chosen communication node to the client communication node via a time distribution protocol, and
iii) differentiating the transmitted first and/or second data into the client communication node to synchronize the client clock with the master clock by means of the timing information and/or frequency reference represented by these differentiated first and second data.

The method according to the invention may include additional characteristics considered separately or combined, and notably:

in step ii) the chosen communication node (used for transmitting the second data) may be different from the source communication node;

in a variant, in step ii) one may use the source communication (timing) node as the chosen communication node for transmitting the second data;
in steps i) and ii) the source communication node may transmit the first data and the second data via two different communication paths (or links) of the data packet network, respectively;
   in steps i) and ii) the source communication node may add a first identifier to the first data and a second identifier to the second data, and in step iii) the client communication node may differentiate the transmitted first and second data from their respective first and second identifiers;
   in a variant, in step i) the source communication node may add a first identifier, designating it, and a second identifier, designating the communication path (or link) used for transmitting the first data, to these first data, and in step ii) the source communication node may add the first identifier, designating it, and a third identifier, designating the other communication path (or link) used for transmitting the second data, to these second data, and in step iii) the client communication node may differentiate the transmitted first and second data from their respective first, second and third identifiers;

in steps i) and ii) one may transmit the first and second data via the same time distribution protocol.

The invention also offers a system, intended for synchronizing a client clock of a client communication node with a master clock in a data packet network, and comprising:

a first module associated to a source communication node and arranged for generating first data representative of timing information of the master clock to be transmitted by the source communication node to the client communication node via a time distribution protocol,

a second module associated to a chosen communication node and arranged for generating second data representative of a frequency reference correlated to the timing information to be transmitted by the chosen communication node to the client communication node via a time distribution protocol, and

a third module associated to the client communication node and arranged for differentiating the transmitted first and second data to provide the timing information and frequency reference they represent, in order the client clock could be synchronized with the master clock by means of this timing information and/or this frequency reference.

The system according to the invention may include additional characteristics considered separately or combined, and notably:

the chosen communication node used for transmitting the second data may be different from the source communication node;

in a variant, the chosen communication node (used for transmitting the second data) may be the source communication node;
the source communication node may be arranged for transmitting the first data and the second data via two different communication paths (or links) of the data packet network, respectively;
   the first module may be arranged for adding a first identifier to the first data and a second identifier to the second data. In this case the third module may be arranged for differentiating the transmitted first and second data from their respective first and second identifiers;
   in a variant, the first module may be arranged for adding a first identifier, designating the source communication node, and a second identifier, designating the communication path (or link) used for transmitting the first data, to these first data, and the second module may be arranged for adding this aforementioned first identifier, designating the chosen communication node, and a third identifier, designating the other communication path (or link) used for transmitting the second data, to these second data. In this case the third module may be arranged for differentiating the transmitted first and second data from their respective first, second and third identifiers.

The invention also offers a third module, intended for being associated to a client communication node connected to a data packet network, and arranged when this client communication node has received first data (representative of timing information of a master clock) from a source communication node and via a time distribution protocol, and/or second data (representative of a frequency reference correlated to these timing information) from a chosen communication node and via a time distribution protocol, for differentiating these received first and second data to provide the timing information and frequency reference they represent, in order a client clock of the client communication node could be synchronized with the master clock by means of this timing information and/or this frequency reference.

This third module may be further arranged for differentiating the transmitted first and second data from first and second identifiers added respectively to them, or for differentiating the transmitted first and second data from first and second identifiers added to the first data and respectively designating the source communication node associated to a first communication path (or link) used for transmitting the first data, and from first and third identifiers added to the second data and respectively designating the chosen communication node and a second communication path (or link), different from the first path (or link) and used for transmitting the second data.

The invention is particularly well adapted, but not exclusively, to the transmission of first and/or second data according to an “over IP” (Internet Protocol) time distribution protocol which is chosen from a group comprising at least IEEE 1588V2/UDP/IP and NTP/UDP/IP.

Other features and advantages of the invention will become apparent on examining the detailed specifications hereafter and the appended drawings, wherein:

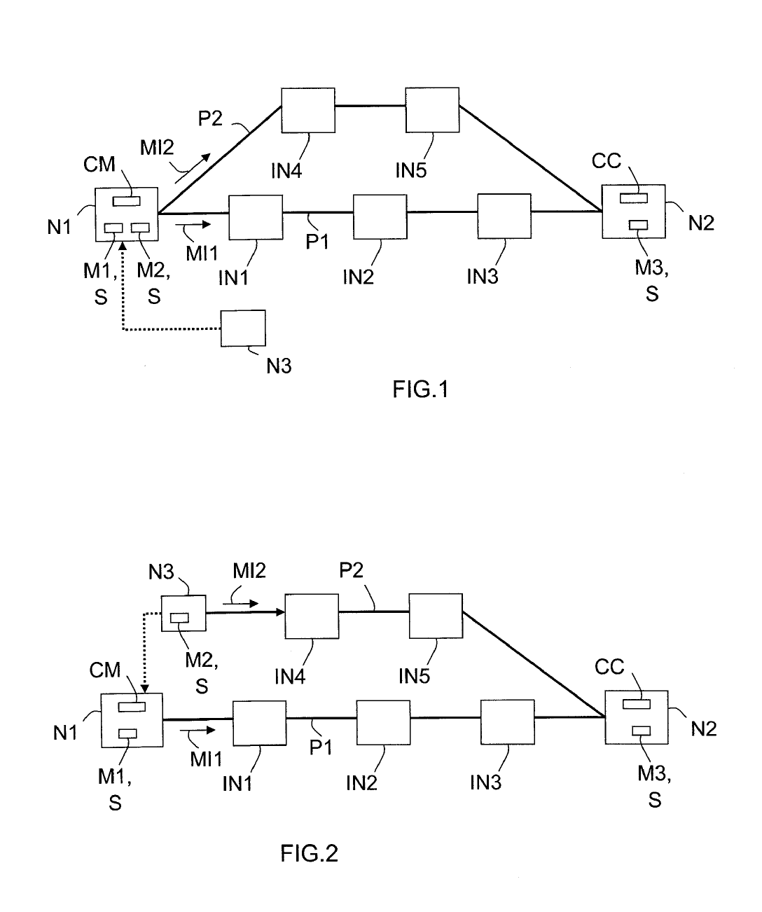

FIG. 1 schematically illustrates a part of a data packet network comprising a source communication node and a client communication node, connected through intermediate communication nodes and equipped respectively with complementary parts of a first example of embodiment of a system according to the invention, and

FIG. 2 schematically illustrates a part of a data packet network comprising a source communication node, an auxiliary communication node and a client communication node, connected through intermediate communication nodes and equipped with complementary parts of a second example of embodiment of a system according to the invention.

The appended drawings may serve not only to complete the invention, but also to contribute to its definition, if need be.

The invention aims at offering a method and an associated system (S) intended for synchronizing client clocks (CC) of client communication nodes (N2) with a master clock (MC) in a data packet network.

In the following description it will be considered, only as example, that the data packet network (or PSN) is a mobile network comprising communication nodes such as base stations to be synchronized. But the invention is not limited to this type of data packet network. Indeed it concerns any type of data packet network or packet switched network (PSN).

As mentioned above, the invention proposes a method intended for synchronizing client clocks CC of client communication nodes (N2) with a master clock (MC) in a data packet network comprising communication nodes.

A part of a data packet network comprising a source communication node N1, a client communication node N2 and five intermediate communication nodes INi (i=1 to 5) is illustrated in FIG. 1. For instance, the client communication nodes N2 are base stations of a radio access network.

The client communication node N2 comprises a (low-cost) client clock CC which must be (time) synchronized with a master clock MC.

In the examples illustrated in FIGS. 1 and 2, the master clock MC is located into the source communication node N1. But this is not mandatory. Indeed, the master clock MC could be located into a network equipment coupled to the source communication node N1.

For instance, the source communication node N1 is a server of synchronization information.

The method according to the invention comprises three main steps.

A first main step (i) consists in transmitting first data, representative of timing information of the master clock MC, from the source communication node N1 to at least one client communication node N2 via a time distribution protocol.

These first data are transmitted into first packets (or messages) MI1. For instance, these first data comprise a timestamp indicating when they have been generated in the server clock reference frame which is correlated to a frequency reference provided by an auxiliary communication node N3. This frequency reference can be of any type. So it can be produced by a local oscillator having a high stability or by a radio navigation system (such as GPS (Global Positioning System), for instance).

In the following description it will be considered, only as example, that the first packets (or messages) MI1 are transmitted via an IP time distribution protocol, such as IEEE 1588V2/UDP/IP or else NTP/UDP/IP, for instance. But the invention is not limited to this type of time distribution protocol. Indeed it concerns any type of time distribution protocol intended for transmitting (or distributing) first packets (or messages) MI1.

The first main step (i) can be implemented by a first module M1 of the system S according to the invention. As illustrated in FIGS. 1 and 2, this first module M1 can be located into the source communication node N1. But this is not mandatory. Indeed, it could be coupled or connected to the source communication node N1. More generally the first module M1 is associated to the source communication node N1.

This first module M1 is arranged for generating first data that will be transmitted into first messages MI1 by the associated source communication node N1 to one or more client communication nodes N2 via the chosen time distribution protocol.

In case where the first module M1 is located into the source communication node N1, it is preferably made of software modules, at least partly. But it could be also made of electronic circuit(s) or hardware modules, or a combination of hardware and software modules. In case where it is made of software modules it can be stored in a memory.

A second main step (ii) of the method according to the invention consists in transmitting second data representative of the frequency reference (which is here provided by the auxiliary communication node N3 and correlated to the timing information represented by the first data) from a chosen communication node to the client communication node N2 via a time distribution protocol.

It is important to note that the first (i) and second (ii) main steps may be carried out in parallel or in series.

In the first example of embodiment illustrated in FIG. 1, the chosen s communication node (also called “syntonization source”) which distributes the frequency reference is the source communication node N1, while in the second example of embodiment illustrated in FIG. 2, the chosen communication node for the distribution of a frequency reference is the auxiliary communication node N3.

The second data are transmitted into second packets (or messages) MI2. For instance, these second data are 1588V2 messages embedding the relevant aforementioned identifiers.

In the following description it will be considered, only as example, that the second packets (or messages) MI2 are transmitted via the same IP time distribution protocol as the one used for transmitting the first packets (or messages) MI1. But this is not mandatory. Indeed two different time distribution protocols may be used for transmitting (or distributing) respectively the first packets (or messages) MI1 and second packets (or messages) MI2.

The second main step (ii) can be implemented by a second module M2 of the system S according to the invention. As illustrated in FIG. 1, this second module M2 can be located into the source communication node N1. But this is not mandatory. Indeed, as illustrated in FIG. 2, this second module M2 can be also located into the auxiliary communication node N3.

This second module M2 is arranged for generating second data that will be transmitted into second messages MI2 by the syntonization source (i.e. the source communication node N1 or the auxiliary communication node N3) to one or more client communication node N2 via the chosen time distribution protocol.

This second module M2 is preferably made of software modules, at least partly. But it could be also made of electronic circuit(s) or hardware modules, or a combination of hardware and software modules (notably when an hardware time-stamping is required). In case where it is made of software modules it can be stored in a memory.

It is important to note that when the first M1 and second M2 modules are located in the source communication node N1, they may be two parts of the same module (or device).

As illustrated in FIG. 1, when the source communication node N1 is in charge of transmitting both the first MI1 and second MI2 messages, it is advantageous that the source communication node N1 transmits the first data in a first communication path (or link) P1 and the second data in a second communication path (or link) P2.

One means here by “first P1 and second P2 communication paths” two communication paths (or links) defined respectively through first and second groups of intermediate nodes INi differing by at least one intermediate node.

It is important to note that it is desirable that the first P1 and second P2 (communication) paths be as different as possible, and optimally that they fully differ.

In the second embodiment illustrated in FIG. 2, the first P1 and second P2 (communication) paths differ because the auxiliary communication node N3 and the source communication node N1 are spatially separated and therefore connected to different intermediate nodes IN1 and IN4, respectively.

A third main step (iii) of the method according to the invention consists in differentiating the transmitted first and/or second data into the client communication node N2 in order to synchronize its client clock CC with the master clock MC by means of the timing information and/or frequency reference represented by these differentiated first and second data.

So, in case where the first MI1 and second MI2 messages follow first P1 and second P2 paths, respectively, as illustrated in FIGS. 1 and 2, if a failure occurs on the first path P1 or on the second path P2 the client communication node N2 will still receive the second messages MI2 or the first messages MI1. The first data contained into the first messages MI1 being representative of timing information correlated to the frequency reference represented by the second data contained into the second messages MI2, whatever the path on which occurs a failure, the client communication node N2 will have at its disposal either the timing information or the frequency reference required for synchronizing its client clock CC.

For instance, if a failure occurs on the first path P1, the stability of the client clock CC is guaranteed despite the loss of the timing information. This stability provides more (delay) margins for the synchronization topology reconfiguration.

If a failure occurs on the second path P2, the frequency reference coming from the syntonization source N1 (FIG. 1) or N3 (FIG. 2) is lost. Nevertheless, the client clock CC still has the time information and therefore can deduce an estimate of this frequency reference from this time information.

The third main step (iii) can be implemented by a third module M3 of the system S according to the invention. As illustrated in FIGS. 1 and 2, this third module M3 can be located into the source communication node N1. But this is not mandatory. Indeed, it could be coupled or connected to the client communication node N2. More generally a third module M3 is associated to a client communication node N2.

This third module M3 is arranged for differentiating the first and second data received by its associated client communication node N2 in order to provide to it the timing information and frequency reference they represent.

This third module M3 is preferably made of software modules, at least partly. But it could be also made of electronic circuit(s) or hardware modules, or a combination of hardware and software modules (notably when hardware operations are required). In case where it is made of software modules it can be stored in a memory.

It is important to note that it is advantageous to make use of identifiers to ease the differentiation of the received first and second data into the client communication node N2.

For instance, in the first step (i) one (the first module M1) may add a specific first identifier to the first data, and in the second step (ii) one (the second module M2) may add a specific second identifier to the second data. In this case the client communication node N2 (or more precisely its associated third module M3) differentiates the received first and second data from their respective first and second identifiers.

To ease differentiation of the received first and second data when a client communication node N2 receive first messages MI1 from several sources communication nodes N1 and/or second messages MI2 from several syntonization nodes N1 or N3, in the first step (i) one (the first module M1) may also add a source identifier to the first data, and in the second step (ii) one (the second module M2) may also add a (syntonization) source identifier to the second data. In this case the client communication node N2 (or more precisely its associated third module M3) differentiates the received first and second data from their respective first and second identifiers but also from their respective source identifiers. The source identifiers may be IP address, for instance.

In a variant, one (the first module M1) may add a first identifier, designating its associated source communication node N1, and a second identifier, designating the first path P1 used by this source communication node N1 for transmitting the first data, to these first data, and in step ii) one (the second module M2) may also add a first identifier, designating the syntonization source, (or chosen communication node) N1 or N3, and a third identifier, designating the other path used for transmitting said second data, to said second data.

In this case the client communication node N2 (or more precisely its associated third module M3) differentiates the received first and second data from their respective first, second and third identifiers. The first identifiers (or source identifiers) may be IP address, for instance.

It is also important to note that both the first messages MI1 and the second messages MI2 could be bi-directional messages exchanged between a source node N1 or N3 and at least one client communication node N2. But in a variant, the first messages MI1 could be bi-directional messages exchanged between a source communication node N1 and a client communication node N2, while the second messages M12 could be one-directional messages transmitted from a syntonization source N1 or N3 to at least one client communication node N2.

It is also important to note that a client communication node N2 may receive second messages MI2 emanating from different syntonization sources N1 or N3. In this case, the client clock CC or the third module M3 may be arranged for selecting the best syntonization source according to at least one source quality criteria such as the “Stratum” field within NTP messages, for instance.

The invention is not limited to the embodiments of method, system and third module described above, only as examples, but it encompasses all alternative embodiments which may be considered by one skilled in the art within the scope of the claims hereafter.

1. A method of synchronizing a client clock of a client communication node with a master clock in a data packet network, wherein the method comprises transmitting first data representative of timing information of said master clock from a source communication node to said client communication node via a time distribution protocol, ii) transmitting second data representative of a frequency reference correlated to said timing information from a chosen communication node to said client communication node via a time distribution protocol, and iii) differentiating said transmitted first and/or second data into said client communication node to synchronize said client clock with said master clock by means of the timing information and/or frequency reference represented by said differentiated first and second data.

2. Method according to claim 1, wherein in step ii) said chosen communication node used for transmitting said second data is different from said source communication node.

3. Method according to claim 1, wherein in step ii) one uses said source communication node as said chosen communication node for transmitting said second data.

4. Method according to claim 3, wherein in steps i) and ii) said source communication node transmits said first data and said second data via two different communication paths of said data packet network, respectively.

5. Method according to claim 4, wherein in steps i) and ii) said source communication node adds a first identifier to said first data and a second identifier to said second data, and in step iii) said client communication node differentiates said transmitted first and second data from their respective first and second identifiers.

6. Method according to claim 4, wherein in step i) said source communication node adds a first identifier, designating said source communication node, and a second identifier, designating the communication path used for transmitting said first data, to said first data, and in step ii) said chosen communication node adds a first identifier, designating said chosen communication node, and a third identifier, designating the other communication path used for transmitting said second data, to said second data, and in step iii) said client communication node differentiates said transmitted first and second data from their respective first, second and third identifiers.

7. Method according to claim 1, wherein in steps i) and ii) one transmits the first and second data via the same time distribution protocol.

8. System for synchronizing a client clock of a client communication node with a master clock in a data packet network, wherein the system comprises i) a first module associated to a source communication node and arranged for generating first data representative of timing information of said master clock to be transmitted by said source communication node to said client communication node via a time distribution protocol, ii) a second module associated to a chosen communication node and arranged for generating second data representative of a frequency reference correlated to said timing information to be transmitted by said chosen communication node to said client communication node via a time distribution protocol, and iii) a third module associated to said client communication node and arranged for differentiating said transmitted first and second data to provide the timing information and frequency reference they represent, in order said client clock could be synchronized with said master clock by means of this timing information and/or this frequency reference.

9. System according to claim 8, wherein said chosen communication node used for transmitting said second data is different from said source communication node.

10. System according to claim 8, wherein said chosen communication node used for transmitting said second data is said source communication node.

11. System according to claim 10, wherein said source communication node is arranged for transmitting said first data and said second data via two different communication paths of said data packet network, respectively.

12. System according to claim 11, wherein said first module is arranged for adding a first identifier to said first data and a second identifier to said second data, and said third module is arranged for differentiating said transmitted first and second data from their respective first second identifiers.

13. System according to claim 11, wherein i) said first module is arranged for adding a first identifier, designating said source communication node, and a second identifier, designating the communication path used for transmitting said first data, to said first data, ii) said second module is arranged for adding a first identifier, designating said chosen communication node, and a third identifier, designating the other communication path used for transmitting said second data, to said second data, and iii) said third module is arranged for differentiating said transmitted first and second data from their respective first, second and third identifiers.

14. Third module intended to be associated to a clients communication node of a data packet network, wherein the third module is arranged when said client communication node has received first data representative of timing information of a master clock from a source communication node and via a time distribution protocol, and/or second data representative of a frequency reference, correlated to said timing information, from a chosen communication node and via a time distribution protocol, for differentiating said received first and second data to provide the timing information and frequency reference they represent, in order a client clock of said client communication node could be synchronized with said master clock by means of this timing information 5 and/or this frequency reference.

15. Third module according to claim 14, wherein the third module is arranged for differentiating said transmitted first and second data from first and second identifiers added respectively to them.

16. Third module according to claim 14, wherein the third module is arranged for differentiating said transmitted first and second data from first and second identifiers added to said first data and respectively designating said source communication node associated to a first communication path used for transmitting said first data, and from first and third identifiers added to said second data and respectively designating said chosen communication node and a second communication path, different from the first communication path and used for transmitting said second data.

17. (canceled)
